(19) United States
(12) Patent Application Publication
(10) Pub. No.: US 2026/0276135 A1
(43) Pub. Date: Sep. 17, 2026

(54) IMAGE PICKUP APPARATUS

(71) Applicant: CANON KABUSHIKI KAISHA, Tokyo (JP)

(72) Inventors: TAKAZUMI SEO, Tokyo (JP); FUMIHIKO TANIMOTO, Kanagawa (JP)

(21) Appl. No.: 19/535,008

(22) Filed: Feb. 10, 2026

(30) Foreign Application Priority Data
Mar. 17, 2025 (JP) 2025-042602

(51) Int. Cl. F16M 11/10; F16M 11/20; F16M 11/38

(52) U.S. Cl. CPC F16M 11/10; F16M 11/2021; F16M 11/38

(57) ABSTRACT

An image pickup apparatus includes a body including an imaging system, and a stand provided on the body. The stand includes a first stand rotatably held by the body and a second stand rotatably held by the first stand. The first stand and the second stand are rotatable among a stored state in which the first stand and the second stand are stored in the body, and a stand state in which the first stand and the second stand extend to opposite sides with respect to the body and respectively contact an installation surface to support the body. The stand holds the body at a plurality of rotation angles in the stand state such that directions of an optical axis of the imaging system differ from each other.

### BACKGROUND

### Field of the Technology

The present disclosure relates to an image pickup apparatus having a stand.

### Description of the Related Art

As disclosed in Japanese Patent Application Laid-Open No. 2000-284357, some image pickup apparatuses are configured to change the tilt of the image pickup apparatus to vary an imaging direction in a vertical (tilt) direction while a built-in stand is opened and the image pickup apparatus is disposed upright on an installation surface.

However, depending on a center-of-gravity position of the tilted image pickup apparatus, the image pickup apparatus may not be maintained in an upright state on the installation surface using the stand. That is, the tilt of the image pickup apparatus in the tilt direction may be limited.

### SUMMARY

An image pickup apparatus according to one aspect of the present disclosure includes a body including an imaging system, and a stand provided on the body. The stand includes a first stand rotatably held by the body and a second stand rotatably held by the first stand. The first stand and the second stand are rotatable among a stored state in which the first stand and the second stand are stored in the body, a first stand state in which the first stand and the second stand extend to the same side with respect to the body and at least one of the first stand and the second stand contacts an installation surface together with the body to support the body, and a second stand state in which the first stand and the second stand extend to opposite sides with respect to the body and respectively contact the installation surface to support the body. The stand holds the body at a plurality of rotation angles in each of the first stand state and the second stand state such that the directions of the optical axis of the imaging system differ from each other.

An image pickup apparatus according to another aspect of the present disclosure includes a body including an imaging system, and a stand provided on the body. The stand includes a first stand rotatably held by the body and a second stand rotatably held by the first stand. The first stand and the second stand are rotatable among a stored state in which the first stand and the second stand are stored in the body, and a stand state in which the first stand and the second stand extend to opposite sides with respect to the body and respectively contact an installation surface to support the body. The stand holds the body at a plurality of rotation angles in the stand state such that the directions of the optical axis of the imaging system differ from each other.

Features of the present disclosure will become apparent from the following description of embodiments with reference to the attached drawings. The following description of embodiments is described by way of example.

### BRIEF DESCRIPTION OF THE DRAWINGS

FIGS. 1A, 1B, and 1C illustrate an external appearance of a camera according to a first embodiment.

FIGS. 2A, 2B, 2C, 2D, 2E, 2F, and 2G illustrate a second stand state (second unfolded state) of the camera according to the first embodiment.

FIGS. 3A, 3B, 3C, and 3D illustrate a first stand state (first unfolded state) of the camera according to the first embodiment.

FIGS. 4A, 4B, 4C, and 4D illustrate a structure of a stand according to the first embodiment.

FIGS. 5A, 5B, 5C, and 5D illustrate another structure of the stand according to the first embodiment.

FIGS. 6A and 6B are a front view and a partial sectional view of the camera according to the first embodiment.

FIGS. 7A and 7B illustrate an external appearance of a camera according to a second embodiment.

FIGS. 8A, 8B, 8C, and 8D illustrate a second stand state of the camera according to the second embodiment.

FIGS. 9A, 9B, and 9C illustrate a first stand state of the camera according to the second embodiment.

FIGS. 10A, 10B, and 10C illustrate a structure of a stand according to the second embodiment.

FIGS. 11A and 11B are a front view and a partial sectional view of the camera according to the second embodiment.

### DESCRIPTION OF THE EMBODIMENTS

Referring now to the accompanying drawings, a description will be given of embodiments according to the present disclosure.

### First Embodiment

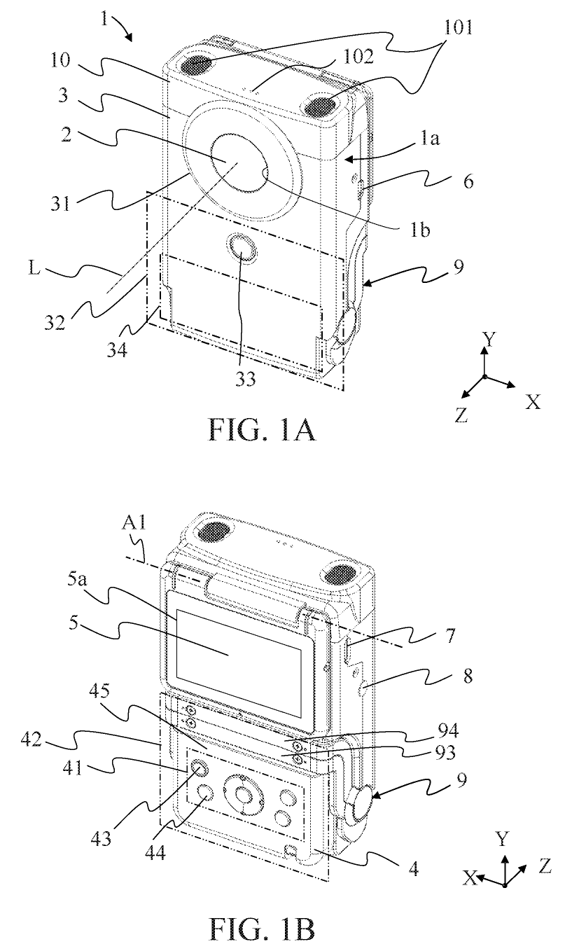

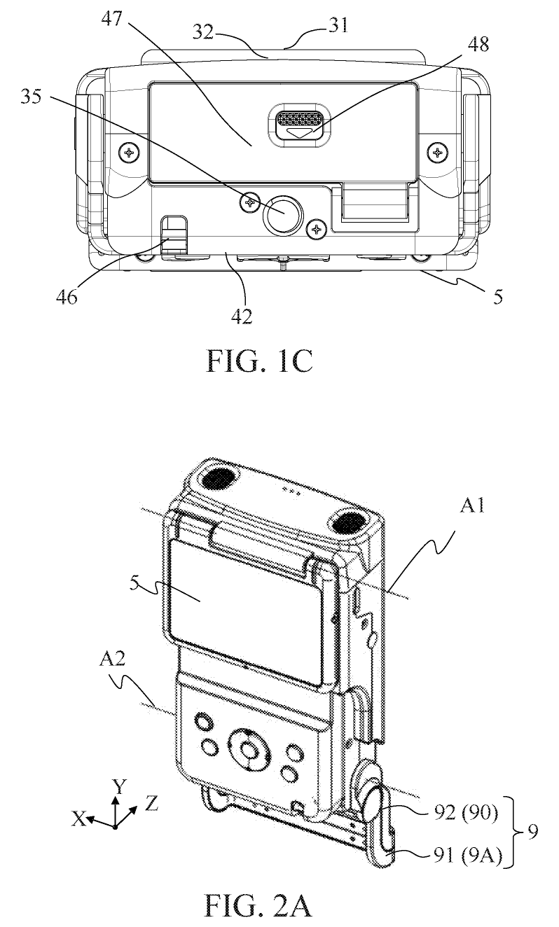

FIGS. 1A, 1B, and 1C illustrate a camera 1 as an image pickup apparatus according to a first embodiment, and are a front perspective view, a rear perspective view, and a bottom view, respectively. As illustrated in FIG. 1A, a left-right direction (horizontal or width direction) of the camera 1 will be defined as an X direction, an up-down direction (vertical or height direction) will be defined as a Y direction, and an optical axis direction (depth or front-rear direction) in which an optical axis L of an imaging system extends will be defined as a Z direction.

A front surface, both side surfaces, a rear surface, and a bottom surface of a body 1a of the camera 1 are covered by a front cover 3 and a rear cover 4 serving as exterior members. A top surface of the body 1a is covered by a top cover 10 serving as an exterior member.

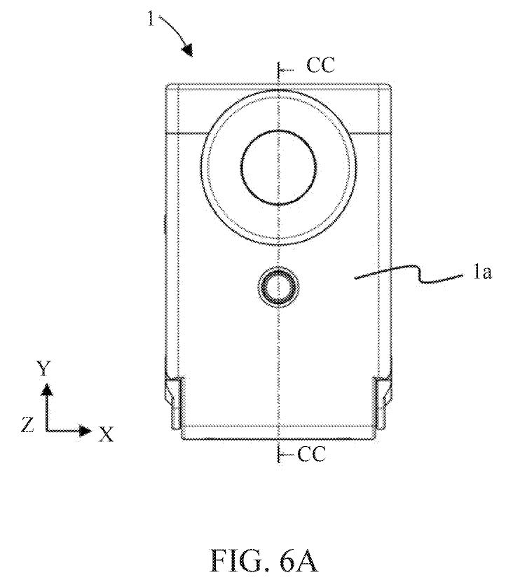

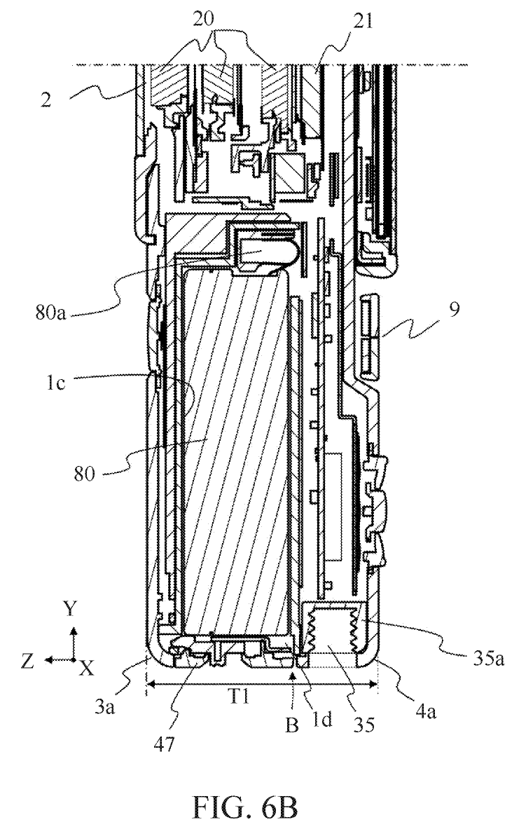

An opening 1b in the imaging system is provided on the front surface of the body 1a, and a lens unit 2 is provided within the opening 1b. FIG. 6B illustrates a plurality of lenses 20 constituting the lens unit 2. The lens unit 2 may be a single-focus lens or a zoom lens, and may include a focus lens that performs focusing by moving in the optical axis direction. The lens unit 2 may be of a type that does not protrude forward from the body 1a regardless of whether the camera 1 is powered on or off, or may be of a type that protrudes forward from the body 1a when the camera 1 is powered on. The imaging system may include an aperture stop and a shutter for controlling light that has passed through the lens unit 2, and an image sensor that photoelectrically converts (captures) an object image, which is an optical image formed by the lens unit 2. FIG. 6B illustrates an image sensor 21.

A front ring 31 is provided on the front cover 3 around an outer circumference of the lens unit 2. Below the front ring 31, a front grip region 32 for a user to hold the camera 1 is provided, and a start/stop button 33 provided on the body 1a is exposed within the front grip region 32. When the start/stop button 33 is pressed while the power of the camera 1 is turned on, imaging (shooting or image capturing) is started, and when the button is pressed again, imaging is stopped. Below the start/stop button 33 within the front grip region 32, a front finger rest region 34 for placing a finger of a user holding the camera 1 is provided.

A display unit 5 and a rear operation member 41 are provided on the rear surface of the body 1a. The display unit 5 includes a display device such as a liquid crystal display or an organic EL display, and has a touch panel 5a capable of detecting a user’s touch operation. When the power of the camera 1 is turned on and a still or moving image capturing mode is set, image data generated by imaging performed by the image sensor 21 is displayed on the display unit 5 as a live-view image. The display unit 5 is rotatable by approximately 180 degrees about an axis A1 extending in the X direction relative to the body 1a via a hinge portion. A user can capture an image while checking composition on the display unit 5 during a selfie.

A rear grip region 42 for a user to hold the camera 1 is provided below the display unit 5 on the rear cover 4.

The rear operation member 41 is exposed within the rear grip region 42 and includes a power button 43 for switching between turning on and off the power of the camera 1, a playback button 44 for instructing playback of recorded image data, and the like. Above the rear operation member 41 within the rear grip region 42, a rear finger rest region 45 for placing a thumb of a user holding the camera 1 is provided.

Intermediate covers 93 and 94, which are exterior members of a stand 9 in a stored state (folded state), are provided in the rear finger rest region 45. The structure of the stand 9 will be described in detail later. In the stored state, the intermediate covers 93 and 94 are configured such that a step difference between the intermediate covers 93 and 94 and the rear grip region 42 is small. That is, the structure prevents the uncomfortable appearance of the camera 1 and does not interfere with gripping of the camera 1.

The start/stop button 33 is disposed on a front side of the rear finger rest region 45, and the front finger rest region 34 is disposed on a front side of the rear operation member 41. With this arrangement, a reliable pressing operation can be performed by a user on operation members to be operated, such as the start/stop button 33 and the rear operation member 41.

Side surfaces of the body 1a are covered by side portions of the front cover 3 and the rear cover 4, and external device connection jacks such as an HDMI (registered trademark) terminal 6, a USB terminal 7, and a microphone input terminal 8 are disposed at a joint portion between the front cover 3 and the rear cover 4. Each of the jacks (6 to 8) is disposed above the front grip region 32 and the rear grip region 42. With this arrangement, cables inserted into the jacks do not interfere when a user holds the camera 1 or places the camera 1 on a desk or the like.

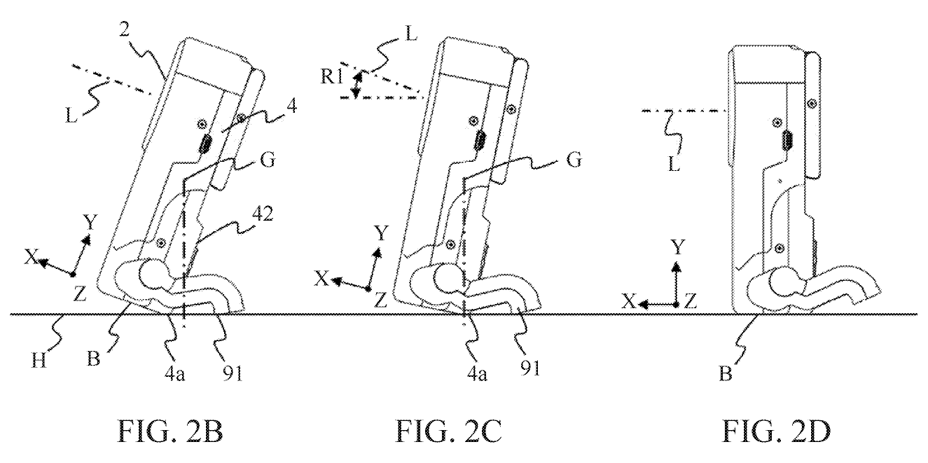

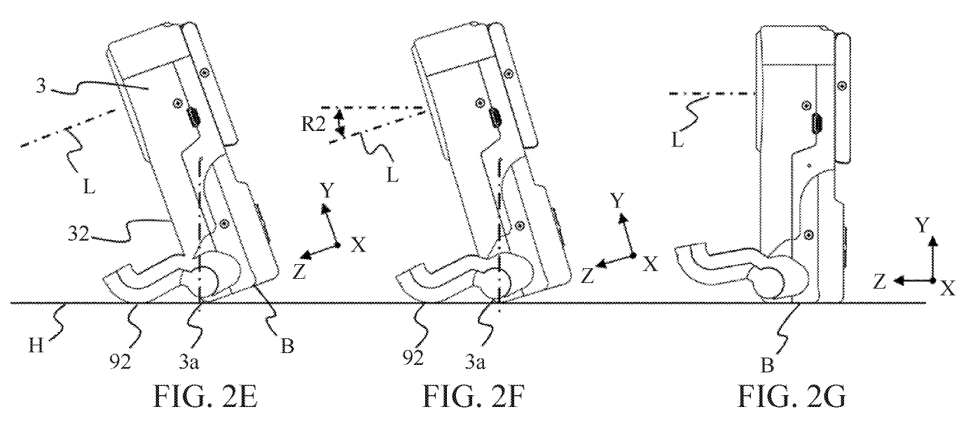

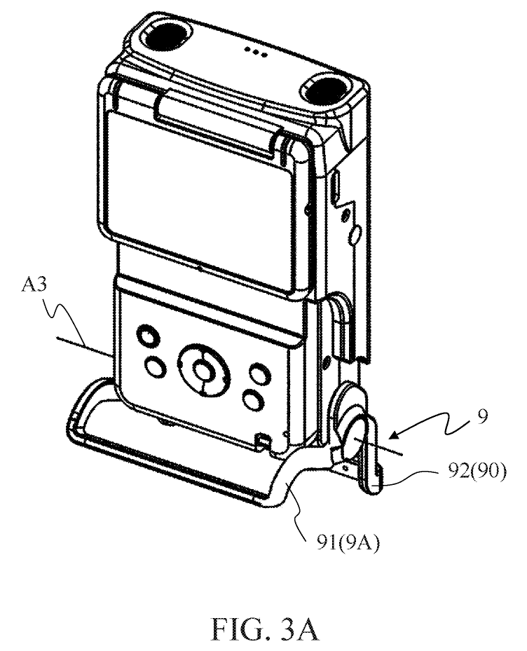

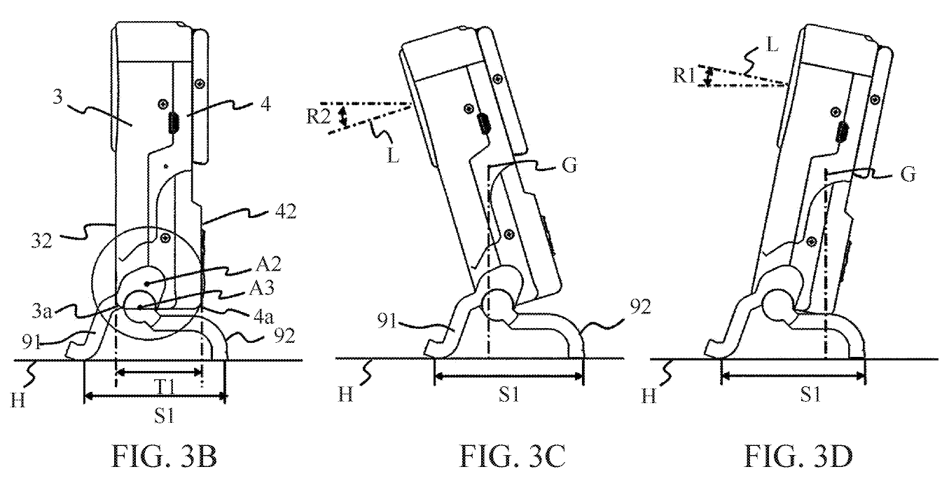

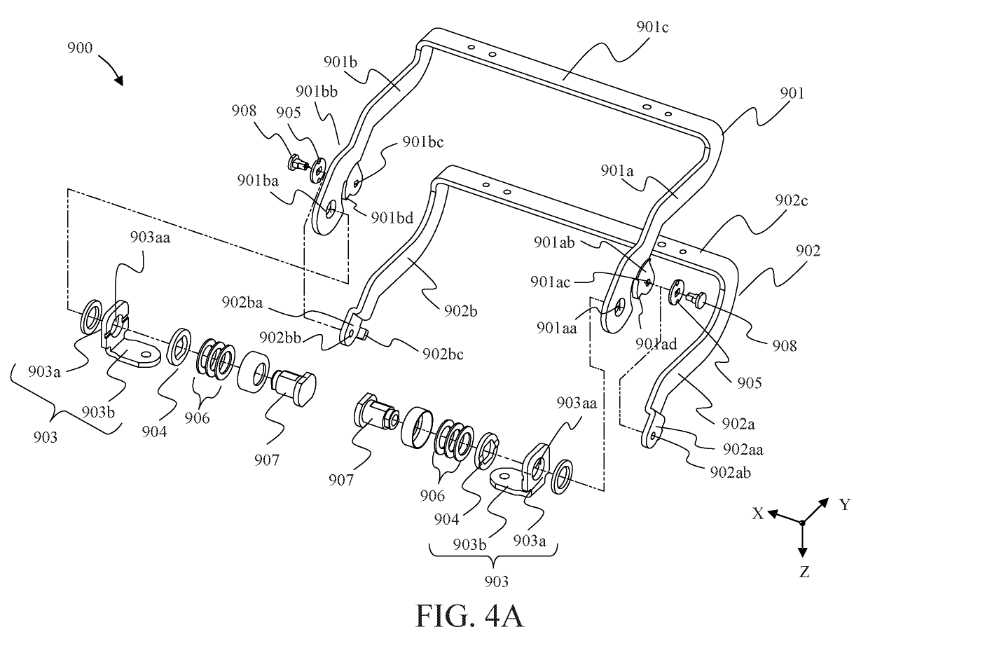

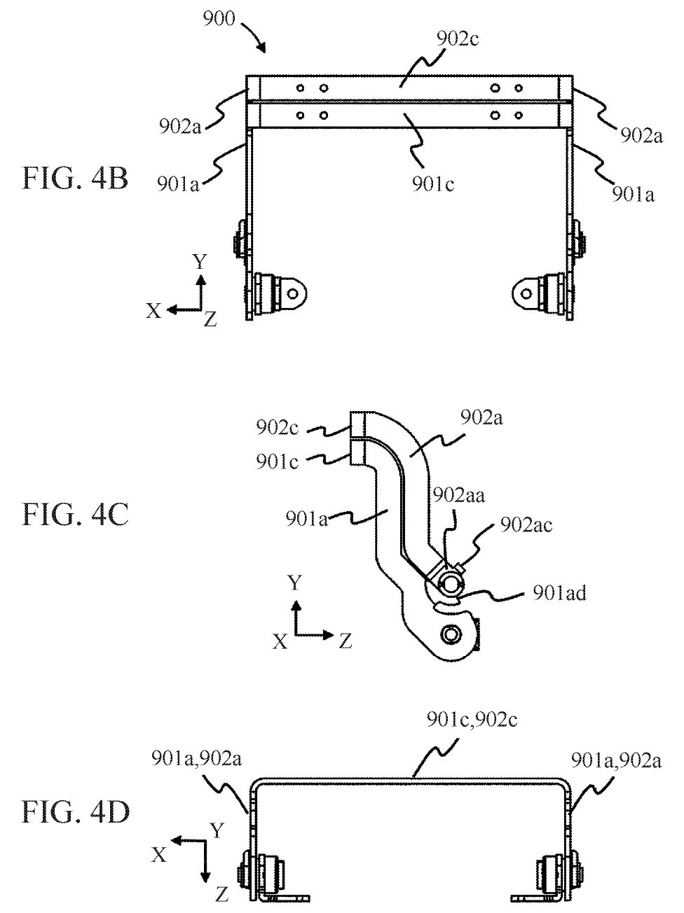

The stand 9 in a stored state is provided on a portion of the side surface of the body 1a in which a front side is the front grip region 32 and a rear side is provided with the rear grip region 42. The stand 9 is rotatable relative to the body 1a about axes A2 and A3, which are rotation axes illustrated in FIGS. 2A and 3A, by a stand hinge 900 illustrated in FIGS. 4A, 4B, and 4C. By using the stand 9 rotated from the stored state, the camera 1 can be held in a plurality of orientations (rotation angles) in which the optical axis L of the imaging system faces various directions in the vertical direction, and can be disposed on an installation surface such as a desk, a table, a stand, or the ground.

On the top surface of the top cover 10, microphone holes 101 disposed on left and right sides with the imaging system interposed therebetween, and a speaker hole 102 disposed above the imaging system are provided. A microphone (not illustrated) is provided below the microphone holes 101 in an upper portion of the body 1a, and external sound is recorded through the microphone. A speaker (not illustrated) is provided below the speaker hole 102 in the upper portion of the body 1a, and operation sounds and sounds included in reproduced moving images are output from the speaker.

A bottom surface of the body 1a is partially covered by a bottom portion of the front cover 3 and a bottom portion of the rear cover 4. On the bottom surface of the body 1a, a tripod attachment portion 35 for attaching the camera 1 to an accessory such as a tripod, a strap attachment portion 46 for passing a strap cord, and a battery lid 47 for opening and closing an opening of a battery chamber for housing a battery 80 illustrated in FIG. 6B and a recording medium (not illustrated) in the body 1a are provided. The battery lid 47 is provided with a lock mechanism (not illustrated) that locks the battery lid 47 in a closed state, and the lock of the battery lid 47 is released by operating a lock release lever 48.

Next, a first usage mode of the stand 9 (first stand state) will be described. As illustrated in FIG. 2A, the display unit 5 is rotatably held about an axis A1 provided at the upper end of the body 1a. On the other hand, the stand 9 is rotatably held about an axis A2 provided at the lower end of the body 1a. Since the display unit 5 and the stand 9 are arranged so as not to overlap each other in the front-rear direction, the stand 9 can be rotated from the stored state illustrated in FIGS. 1A and 1B even when the display unit 5 is in a closed state relative to the body 1a.

FIG. 2B illustrates a state in which the stand 9 is rotated rearward from the stored state to support the camera 1 on an installation surface (horizontal surface) H in an upward tilt orientation (tilt orientation), in which the optical axis L of the imaging system (lens unit 2) has an upward tilt angle relative to the installation surface H. The stand 9 includes a main stand (first stand) 9A having a first side cover 91 as an exterior member, and a sub-stand (second stand) 90 having a second side cover 92 as an exterior member. As will be described later, the sub-stand 90 is held by the main stand 9A. Therefore, when the main stand 9A is rotated about the axis A2, the sub-stand 90 is rotated integrally therewith.

In FIG. 2B, each first side cover 91 of the main stand 9A is rotated to a position behind the rear cover 4 and above the bottom surface B of the body 1a. At a ridge line where the bottom surface B and the rear grip region 42 intersect on the rear cover 4, a rounded fillet 4a is formed. A rear portion of each first side cover 91 and the fillet 4a contact the installation surface H.

As illustrated in FIG. 2B, in the upward tilt orientation in which the optical axis L has a tilt angle greater than a tilt angle R1 illustrated in FIG. 2C relative to the installation surface H, the center of gravity G of the body 1a is located behind the fillet 4a. As a result, the upward tilt orientation of the body 1a is stably maintained.

On the other hand, as illustrated in FIG. 2C, when the optical axis L has the tilt angle R1 relative to the installation surface H, the center of gravity G of the body 1a is located in front of the fillet 4a. As a result, the body 1a transitions to an upright state in which only the bottom surface B is in contact with the installation surface H, as illustrated in FIG. 2D, and the upward tilt orientation is not maintained.

FIG. 2E illustrates a state in which the stand 9 is rotated from the stored state past the rear side to the front side, thereby supporting the camera 1 on the installation surface H in a downward tilt orientation (perspective orientation), in which the optical axis L of the imaging system has a downward tilt angle relative to the installation surface H. In this state, the second side cover 92 of the stand 9 is rotated to a position in front of the front cover 3 and above the bottom surface B of the body 1a. At a ridge line where the bottom surface B and the front grip region 32 intersect on the front cover 3, a fillet 3a with rounded corners is formed. A front portion of the second side cover 92 and the fillet 3a are in contact with the installation surface H.

As illustrated in FIG. 2E, in a downward tilt orientation in which the optical axis L has a tilt angle greater than a tilt angle R2 illustrated in FIG. 2F relative to the installation surface H, the center of gravity G of the body 1a is located in front of the fillet 3a. As a result, the downward tilt orientation of the body 1a is stably maintained.

On the other hand, as illustrated in FIG. 2F, when the optical axis L has the tilt angle R2 relative to the installation surface H, the center of gravity G of the body 1a is located behind the fillet 3a. As a result, the body 1a transitions to an upright orientation in which only the bottom surface B is in contact with the installation surface H, as illustrated in FIG. 2G, and the downward tilt orientation is not maintained.

Next, a second usage mode of the stand 9 (second stand state) will be described. FIGS. 3A and 3B illustrate a state in which the main stand 9A is rotated about the axis A2 from the stored state past the rear side to the front side, and the sub-stand 90 is rotated rearward from the stored state about an axis A3 parallel to the axis A2.

Thus, by opening the main stand 9A and the sub-stand 90 in the front-rear direction such that the first side cover 91 of the main stand 9A and the second side cover 92 of the sub-stand 90 are in contact with the installation surface H, the body 1a is supported without the bottom surface B contacting the installation surface H. That is, the body 1a is supported at a position above the installation surface H. At this time, as illustrated in FIG. 3B, by setting an interval (stand interval) S1 between the portions of the first side cover 91 and the second side cover 92 that contact the installation surface H to be wider than a front-rear thickness T1 of the body 1a, the body 1a is stably supported.

As illustrated in FIGS. 3C and 3D, even in the upward/downward tilt orientations having the tilt angles R1 and R2 illustrated in FIGS. 2C and 2F (and smaller tilt angles), the center of gravity G of the body 1a is located within the stand interval S1, and therefore these orientations are maintained.

When the body 1a placed on the installation surface H in the first usage mode returns to the upright orientation with a small tilt angle, the user can easily maintain the upward/downward tilt orientation with a small tilt angle by opening the main stand 9A and the sub-stand 90 in the front-rear direction to switch to the second usage mode.

Thus, by supporting the body 1a solely with the stand 9 while separating it from the installation surface H using the second usage mode, the body 1a can be held in the upward/downward tilt orientations with a small tilt angle regardless of the positions or sizes of the fillets 3a and 4a on the bottom surface B. Therefore, the tilt angle range of the camera 1 placed on the installation surface H can be expanded.

FIG. 4A is an exploded view of the stand hinge 900. The stand hinge 900 mainly includes a first support member 901, a second support member 902, a fixing plate 903, a first friction plate 904, a second friction plate 905, a disc spring 906, a first shaft 907, and a second shaft 908.

The first support member 901 and the second support member 902 are manufactured by sheet-metal press working and have a U shape. The first support member 901 serves as a structural frame of the main stand 9A, and the second support member 902 serves as a structural frame of the sub-stand 90.

The first support member 901 includes a pair of arm portions 901a and 901b extending on both left and right sides of the body 1a in directions orthogonal to the axis A2 illustrated in FIG. 2A, and a coupling portion 901c that connects distal ends of the arm portions 901a and 901b opposite to proximal ends on the axis A2 side. The proximal ends of the arm portions 901a and 901b are provided with hole portions 901aa and 901ba. Bearing portions 901ab and 901bb are provided on the arm portions 901a and 901b at positions closer to the distal ends than the proximal ends, and the bearing portions 901ab and 901bb are provided with hole portions 901ac and 901bc.

The second support member 902 includes a pair of arm portions 902a and 902b extending on both left and right sides of the body 1a in directions orthogonal to the axis A3 illustrated in FIG. 3A, and a coupling portion 902c that connects distal ends of the arm portions 902a and 902b opposite to proximal ends on the axis A3 side. Sliding portions 902aa and 902ba are provided at the proximal ends of the arm portions 902a and 902b, and hole portions 902ab and 902bb are provided in the sliding portions 902aa and 902ba.

Near the hole portions 902ab and 902bb, protrusions 902ac and 902bc bent in a direction parallel to the axis A3 are formed. The protrusions 902ac and 902bc function as stoppers that contact contact surfaces 901ad and 901bd provided on the bearing portions 901ab and 901bb of the first support member 901 in the second usage mode, thereby restricting rotation of the sub-stand 90.

The first and second support members 901 and 902 are required to have high rigidity against forces applied during rotation of the stand 9. In general, sheet metal has high rigidity and is less likely to deform against loads applied from directions orthogonal to the thickness direction. Therefore, by forming the arm portions (901a, 901b, 902a, and 902b) in the shapes illustrated in FIG. 4A, the arm portions can achieve high rigidity. In addition, since sheet-metal parts generally have a smaller thickness than width, forming the coupling portions (901c and 902c) in the shapes illustrated in FIG. 4A can suppress a size increase in the thickness direction (Z direction) of the camera 1 in the stored state. That is, forming the first and second support members 901 and 902 in U shapes in which the pair of arm portions are coupled by the coupling portion can secure rigidity while suppressing a size increase in the thickness direction of the camera 1.

The fixing plates 903 provided for the respective arm portions 901a and 901b of the first support member 901 are manufactured by sheet-metal press working and are fixed to the front cover 3 by screws. Each fixing plate 903 is formed in an L shape and includes a bearing portion 903a orthogonal to the axis A2 and a fixing portion 903b extending parallel to the axis A2 from a lower end of the bearing portion 903a. The bearing portion 903a has a hole portion 903aa. Each fixing plate 903 is disposed such that the fixing portion 903b is located inside the corresponding arm portion 901a or 901b. The hole portions 901aa and 901ba of the arm portions 901a and 901b and the hole portion 903aa of the fixing plate 903 are arranged coaxially, and the first shaft 907 having the axis A2 as its central axis is inserted into these hole portions.

The first shaft 907 is manufactured by metal cutting and serves as a rotation center shaft of the stand 9 (main stand 9A). The first shaft 907 is inserted from the inner side of the fixing plate 903 through the disc spring 906 and the friction plate 904 into the hole portion 901aa or 901ba and the hole portion 903aa, and is caulked on the outer side. Thereby, the first support member 901 is rotatably coupled to the fixing plate 903 about the axis A2.

The friction plate 904 and the disc spring 906 are sandwiched between a head portion of the first shaft 907 and the bearing portion 903a of the fixing plate 903, and the disc spring 906 is in a deflected state in the direction of the axis A2. A biasing force generated by the disc spring 906 presses the friction plate 904 against the bearing portion 903a of the fixing plate 903, thereby setting a torque required for rotation of the first support member 901 relative to the fixing plate 903 (that is, a torque for holding the rotational position of the first support member 901). By properly setting this torque, the first support member 901 can be held at any of a plurality of rotational positions relative to the fixing plate 903. By providing a plurality of concave portions near the hole portion 903aa of the bearing portion 903a of the fixing plate 903 with which a protrusion of the friction plate 904 is engaged, a click feeling may be generated at the plurality of rotational positions of the first support member 901.

The bearing portions 901ab and 901bb provided on the arm portions 901a and 901b of the first support member 901 are disposed inside the sliding portions 902aa and 902ba of the second support member 902. Thereby, the hole portions 902ab and 902bb provided in the sliding portions 902aa and 902ba and the hole portions 901ac and 901bc of the first support member 901 are arranged coaxially, and the second shaft 908 is inserted from the outside into the hole portions 902ab, 902bb, 901ac, and 901bc. The sliding portions 902aa and 902ba are portions that are rotatably held by the first support member 901.

The second shaft 908 is manufactured by metal cutting and serves as a rotation center shaft of the sub-stand 90. The second shaft 908 is inserted from the outer sides of the arm portions 902a and 902b of the second support member 902, through the friction plate 905, into the hole portions 902ab and 902bb of the second support member 902 and the hole portions 901ac and 901bc of the first support member 901, and is caulked on the inner side. Thereby, the second support member 902 is rotatably connected to the first support member 901 about the axis A3.

The friction plate 905 is sandwiched between a head portion of the second shaft 908 and the bearing portions 901ab and 901bb of the first support member 901. By pressing protrusions provided on the friction plate 905 against the bearing portions 901ab and 901bb, a torque required for rotation of the second support member 902 relative to the first support member 901 can be set. Unlike the first support member 901, the second support member 902 may not be held at arbitrary rotational positions. Therefore, the torque required for rotation of the second support member 902 is smaller than the torque required for rotation of the first support member 901. Since no disc spring is provided for the friction plate 905, the structure can be made thinner than the combination of the friction plate 904 and the disc spring 906.

FIGS. 4B, 4C, 4D respectively illustrate the stand hinge 900 in the stored state when viewed from the rear side, the side, and the bottom side. In the stored state, as illustrated in FIGS. 4B and 4C, the coupling portions 901c and 902c of the first and second support members 901 and 902 are disposed close to each other in the Y direction so as not to overlap each other in the XY plane (Z direction). That is, as illustrated in FIG. 4D, the coupling portions 901c and 902c are disposed along the rear surface of the body 1a so as to overlap in the Y direction.

As illustrated in FIG. 4C, portions of the arm portion 901a of the first support member 901 and the arm portion 902a of the second support member 902 other than the sliding portions 902aa and 902ba are disposed close to each other in the Y direction so as not to overlap each other in the YZ plane (X direction as the rotation axis direction). That is, as illustrated in FIG. 4B, the arm portions 901a and 902a are disposed so as to overlap each other in the XY plane (Y direction). The same arrangement is applied to the arm portions 901b and 902b. With such an arrangement, the area occupied by the stand hinge 900 in the XY plane and the YZ plane can be reduced, and the thickness of the stand hinge 900 in the Z direction can also be reduced.

As illustrated in FIG. 4C, the sliding portions 902aa and 902ba of the second support member 902 overlap the arm portions 901a and 901b of the first support member 901 and the friction plate 905 in the YZ plane (X direction), and therefore protrude in the X direction. However, by reducing the thickness of the friction plate 905, the protrusion in the X direction can be suppressed.

As illustrated in FIG. 4C, the arm portions 902a and 902b of the second support member 902 are disposed in front of the arm portions 901a and 901b of the first support member 901. The coupling portion 902c of the second support member 902 is disposed above the coupling portion 901c of the first support member 901 and is rotatably held in a clockwise direction relative to the coupling portion 901c. Alternatively, the arm portions 902a and 902b may be disposed behind the arm portions 901a and 901b, and the coupling portion 902c may be disposed below the coupling portion 901c and be rotatable in a counterclockwise direction.

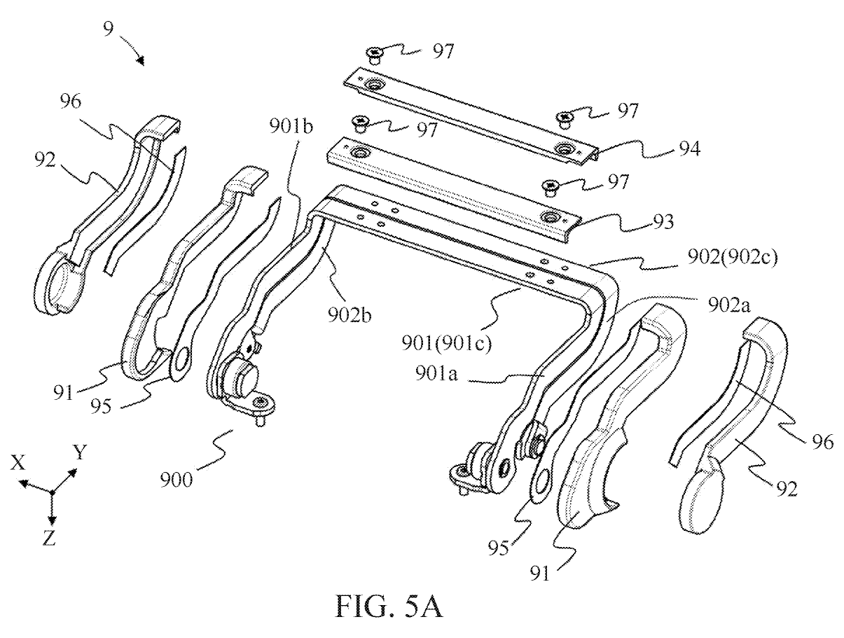

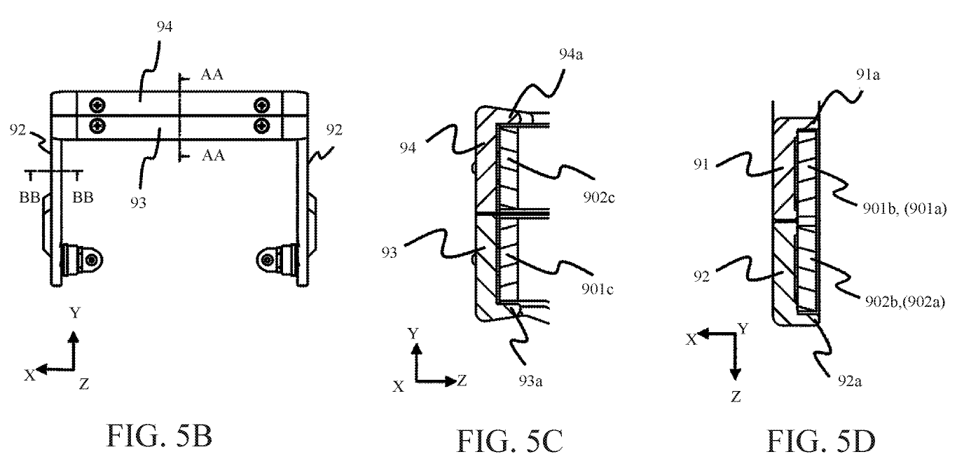

FIG. 5A is an exploded view of the stand 9 including the stand hinge 900. FIG. 5C illustrates a cross section taken along a line AA-AA in FIG. 5B, which illustrates the stand 9 when viewed from the rear, and FIG. 5D illustrates a cross section taken along a line BB-BB in FIG. 5B.

As described above, the stand 9 in the stored state is disposed in the rear grip region 42. However, since the stand hinge 900 mainly made from sheet-metal parts has low grip performance, resin covers (91, 92, 93, and 94) are attached to the stand hinge 900 so as to cover it.

The stand 9 includes the stand hinge 900, a pair of first side covers 91, a pair of second side covers 92, a first intermediate cover 93, and a second intermediate cover 94. The pair of first side covers 91 and the pair of second side covers 92 are fixed to the arm portions 901a and 901b of the first support member 901 and the arm portions 902a and 902b of the second support member 902 by double-sided tapes 95 and 96, respectively. Thereby, as illustrated in FIGS. 1B and 5B, the side surfaces and the front and rear end surfaces of the arm portions 901a, 901b, 902a, and 902b are covered. The first intermediate cover 93 and the second intermediate cover 94 are fixed to the coupling portions 901c and 902c of the first and second support members 901 and 902 by two screws 97, respectively. Thereby, as illustrated in FIGS. 1B and 5B, the rear surfaces of the coupling portions 901c and 902c in the stored state are covered.

As illustrated in FIGS. 5C and 5D, in the stored state in which the first support member 901 and the second support member 902 are disposed close to each other, the covers (91, 92, 93, and 94) form exterior surfaces of the camera 1. End surfaces of the covers opposite to sides where the first and second support members 901 and 902 approach each other are covered by extending portions (91a, 92a, 93a, and 94a) extending from the respective covers. That is, by disposing the first support member 901 and the second support member 902 close to each other in the stored state, it is unnecessary to cover end surfaces on sides where the first support member 901 and the second support member 902 face each other. Thereby, the area occupied by the stand 9 on the rear surface and side surfaces of the camera 1 can be suppressed.

In the present embodiment described above, covers (91, 92, 93, and 94) are attached to outer surfaces of the stand 9 that form the exterior of the camera 1 and also serve as a grip region for a user in the stored state of the stand 9. Thereby, the appearance of the camera 1 can be improved and grip performance can also be enhanced. In the first and second usage modes, portions of the first and second support members 901 and 902 that are not covered by the covers are visible to the user; however, by applying decorative processing such as painting or plating to those portions, the appearance can be improved.

On the other hand, by adopting a structure in which inner surfaces of the first and second support members 901 and 902 and end surfaces on sides where they approach each other are not covered by the covers, an increase in the size of the camera 1 can be suppressed.

The pair of first side covers 91 and the first intermediate cover 93 may be an integral molded part, or the pair of second side covers 92 and the second intermediate cover 94 may be an integral molded part. The covers (91, 92, 93, and 94) may be fixed by thermal caulking instead of fixing by double-sided tape or screws.

FIG. 6B illustrates a part on the bottom surface side of a cross section obtained by cutting the camera 1 illustrated in FIG. 6A along a line CC-CC. Inside the body 1a, a battery chamber 1c for accommodating a battery 80 is provided, and a battery contact 80a is disposed at an upper end of the battery chamber 1c. The battery chamber 1c has an opening 1d that opens at the bottom surface B of the body 1a, and the opening 1d is closed by the battery lid 47 described above. A female screw portion 35a is formed in a tripod attachment portion 35 provided on the bottom surface B of the body 1a on a rear side of the battery lid 47.

Here, the battery lid 47 cannot be smaller than the size of the battery 80 in order to allow insertion and removal of the battery 80. The tripod attachment portion 35 also cannot be smaller because the general-purpose female screw portion 35a is provided therein. That is, the thickness T1 of the camera in the Z direction is determined by the sizes of the battery lid 47 and the tripod attachment portion 35. In a case where the thickness T1 is reduced, the fillets 3a and 4a of the bottom surface B also become smaller. When the fillets 3a and 4a become smaller, as described with reference to FIGS. 2C, 2D, 2F, and 2G, it becomes impossible to maintain a tilt orientation with a small tilt angle in the first usage mode of the stand 9 due to the relationship with the center of gravity G of the body 1a.

However, as described with reference to FIGS. 3C and 3D, by configuring the stand 9 with the main stand 9A and the sub-stand 90, a tilt orientation with a small tilt angle can be maintained in the second usage mode of the stand 9.

Since the stand 9 in the stored state is accommodated in a concave portion between the display unit 5 and the rear operation member 41 and fits within the thickness T1 of the body 1a, an increase in the thickness of the camera 1 due to provision of the stand 9 can be suppressed.

### Second Embodiment

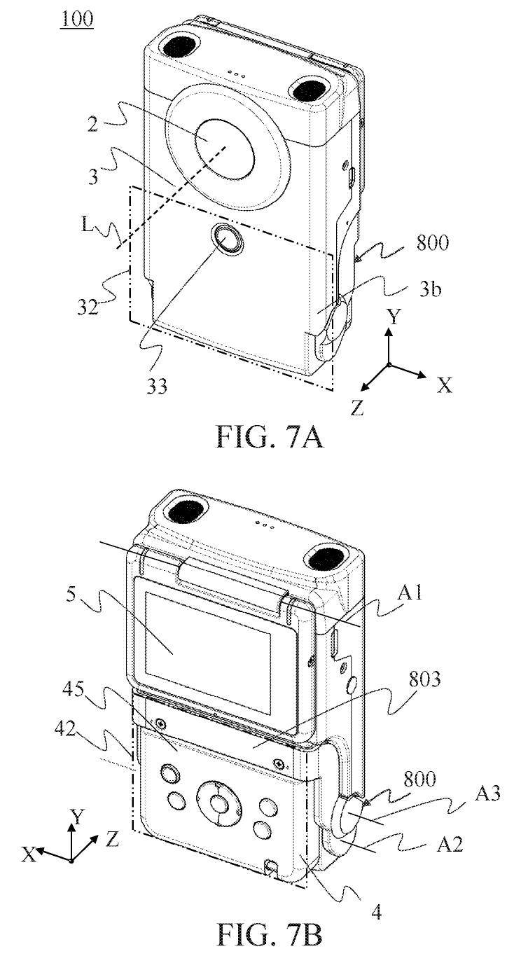

FIGS. 7A and 7B are a front perspective view and a rear perspective view of a camera 100 according to a second embodiment, respectively. The camera 100 according to the second embodiment differs from the camera 1 according to the first embodiment in the structure of a stand 800. Thus, the structure of the stand 800 in the present embodiment will be mainly described below, and components common to those of the first embodiment will be designated by the same reference numerals as in the first embodiment and a description thereof will be omitted. The X, Y, and Z directions are the same as those in the first embodiment.

In the body 1a, the stand 800 in the stored state is disposed from a side surface between the front grip region 32 and the rear grip region 42 to a rear finger rest region 45 within the rear grip region 42. An intermediate cover 803, which serves as an exterior member of the stand 800 in the stored state, is disposed in the rear finger rest region 45. The intermediate cover 803 is configured such that a step between the intermediate cover 803 and the rear grip region 42 is reduced in the stored state. That is, this structure prevents an unnatural appearance of the camera 100 and does not interfere with gripping of the camera 1.

The stand 800 is rotatably connected to the body 1a by the stand hinge 900 illustrated in the first embodiment, about the axes A2 and A3 extending in the X direction.

Next, a first usage mode (first stand state) of the stand 800 will be described. As illustrated in FIG. 7B, the display unit 5 is rotatably held about the axis A1 provided at an upper end of the body 1a. On the other hand, the stand 800 is rotatably held about the axis A2 provided at a lower end of the body 1a. Since the display unit 5 and the stand 800 are arranged so as not to overlap each other in the front-rear direction, the stand 800 can be rotated from the stored state illustrated in FIGS. 7A and 7B even when the display unit 5 is in a closed state relative to the body 1a.

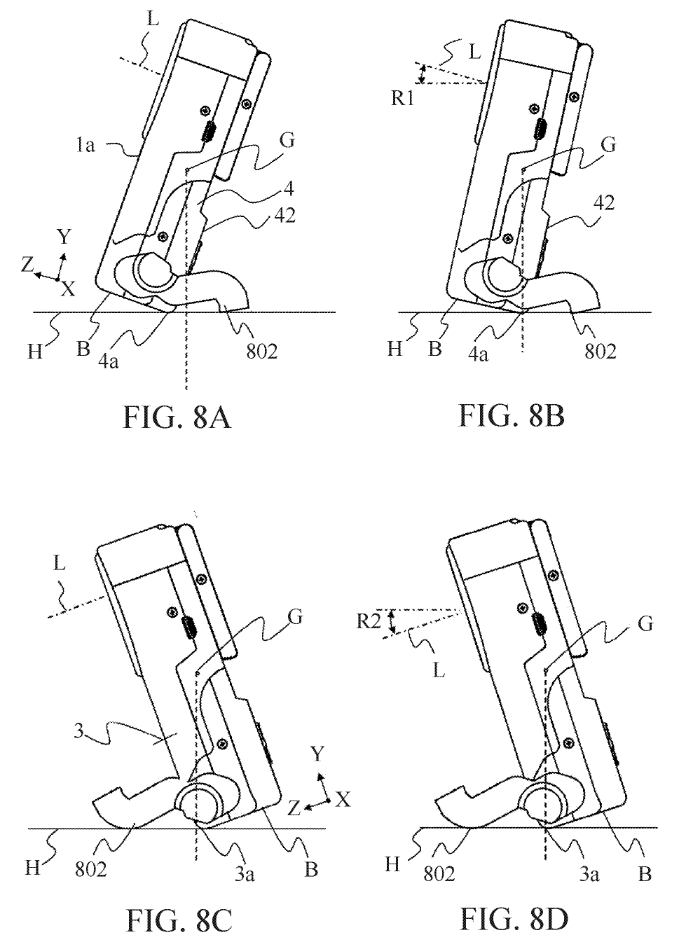

FIG. 8A illustrates a state in which the stand 800 is rotated rearward from the stored state, and the camera 100 is supported on the installation surface (horizontal surface) H in an upward tilt orientation (tilt-up orientation) in which the optical axis L of the imaging system (lens unit 2) has an upward tilt angle. The stand 800 includes a side cover 802 as an exterior member.

In FIG. 8A, the side cover 802 of the stand 800 is rotated to a position behind the rear cover 4 and above a bottom surface B of the body 1a. A fillet 4a with rounded corners is formed at a ridge line where the bottom surface B and the rear grip region 42 intersect on the rear cover 4. A rear portion of the side cover 802 and the fillet 4a are in contact with the installation surface H.

As illustrated in FIG. 8A, in an upward tilt orientation in which the optical axis L has a tilt angle greater than a tilt angle R1 illustrated in FIG. 8B relative to the installation surface H, the center of gravity G of the body 1a is located behind the fillet 4a. As a result, the upward tilt orientation of the body 1a is stably maintained.

On the other hand, as illustrated in FIG. 8B, when the optical axis L has the tilt angle R1 relative to the installation surface H, the center of gravity G of the body 1a is located approximately at the same horizontal position as the fillet 4a and is not located behind the fillet 4a. As a result, the body 1a tends to transition to an upright state in which only the bottom surface B contacts the installation surface H, as illustrated in FIG. 2D of the first embodiment, and the upward tilt orientation is not stably maintained.

FIG. 8C illustrates a state in which the stand 800 is rotated from the stored state past the rear side to the front side, and the camera 100 is supported on the installation surface H in a downward tilt orientation (perspective orientation) in which the optical axis L of the imaging system has a downward tilt angle. In this state, the side cover 802 of the stand 800 is rotated to a position in front of the front cover 3 and above the bottom surface B of the body 1a. The fillet 3a with rounded corners is formed at a ridge line where the bottom surface B and the front grip region 32 intersect on the front cover 3. A front portion of the side cover 802 and the fillet 3a contact the installation surface H.

As illustrated in FIG. 8C, in a downward tilt orientation in which the optical axis L has a tilt angle greater than a tilt angle R2 illustrated in FIG. 8D relative to the installation surface H, the center of gravity G of the body 1a is located in front of the fillet 3a. As a result, the downward tilt orientation of the body 1a is stably maintained.

On the other hand, as illustrated in FIG. 8D, when the optical axis L has the tilt angle R2 relative to the installation surface H, the center of gravity G of the body 1a is located approximately at the same horizontal position as the fillet 3a and is not located in front of the fillet 3a. As a result, the body 1a tends to transition to an upright orientation in which only the bottom surface B contacts the installation surface H, as illustrated in FIG. 2G of the first embodiment, and the downward tilt orientation is not stably maintained.

Next, a second usage mode (second stand state) of the stand 800 will be described. As in the first embodiment, the stand 800 includes a main stand (first stand) 800A that is rotatable about the axis A2 relative to the body 1a, and a second support member 902 serving as a sub-stand (second stand) that is rotatable about the axis A3 parallel to the axis A2. The second support member 902 is rotatably held by the main stand 800A (a first support member 901 described later) about the axis A3. The side cover 802 is part of the main stand 800A.

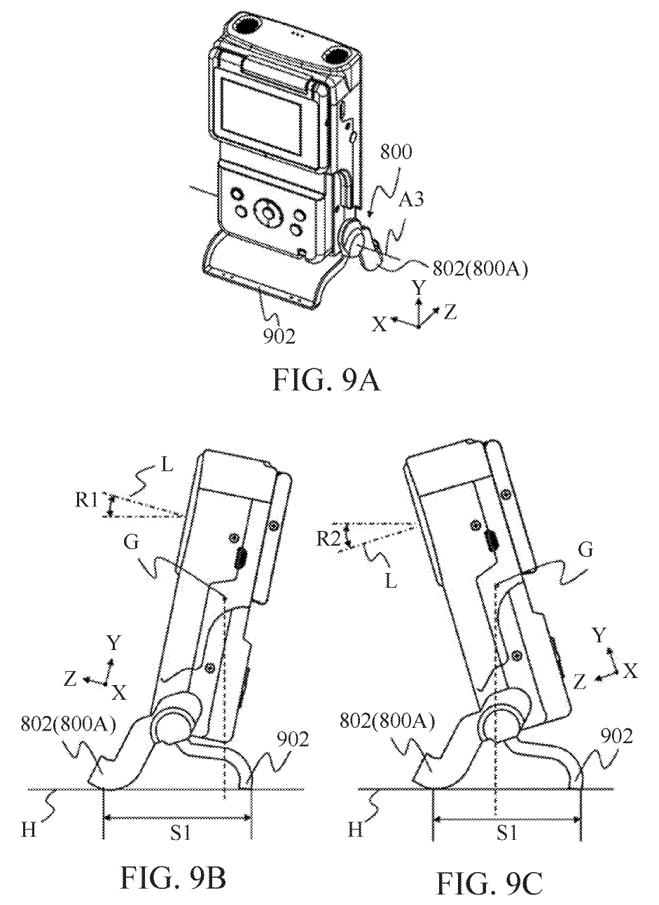

FIGS. 9A, 9B, and 9C illustrate a state in which the main stand 800A (side cover 802) is rotated from the stored state about the axis A2 past the rear side to the front side, and the second support member 902 is rotated rearward from the stored state about the axis A3. Thus, when the main stand 800A and the second support member 902 as the sub-stand are opened in the front-rear direction, and the side cover 802 of the main stand 800A and the second support member 902 contact the installation surface H, the body 1a is supported without the bottom surface B contacting the installation surface H. That is, the body 1a is supported at a position above the installation surface H. At this time, as illustrated in FIGS. 9B and 9C, by setting a stand interval S1 between portions of the side cover 802 and the second support member 902 that contact the installation surface H to be larger than the thickness T1 of the body 1a in the front-rear direction, the body 1a is stably supported.

FIGS. 9B and 9C illustrate the camera 100 in the tilt orientations with the tilt angles R1 and R2 illustrated in FIGS. 8B and 8D. Even in such upward/downward tilt orientations with a small tilt angle, the center of gravity G of the body 1a is located within the stand interval S1, so that these orientations are maintained.

In a case where the body 1a placed on the installation surface H in the first usage mode returns to an upright orientation with a small tilt angle, the user can easily maintain the upward/downward tilt orientations with a small tilt angle by opening the main stand 800A and the second support member 902 in the front-rear direction to switch to the second usage mode.

Thus, by supporting the body 1a solely with the stand 800 while separating the body 1a from the installation surface H using the second usage mode, the body 1a can be held in the upward/downward tilt orientations with a small tilt angle regardless of the positions or sizes of the fillets 3a and 4a on the bottom surface B. Therefore, the tilt angle range of the camera 100 placed on the installation surface H can be expanded.

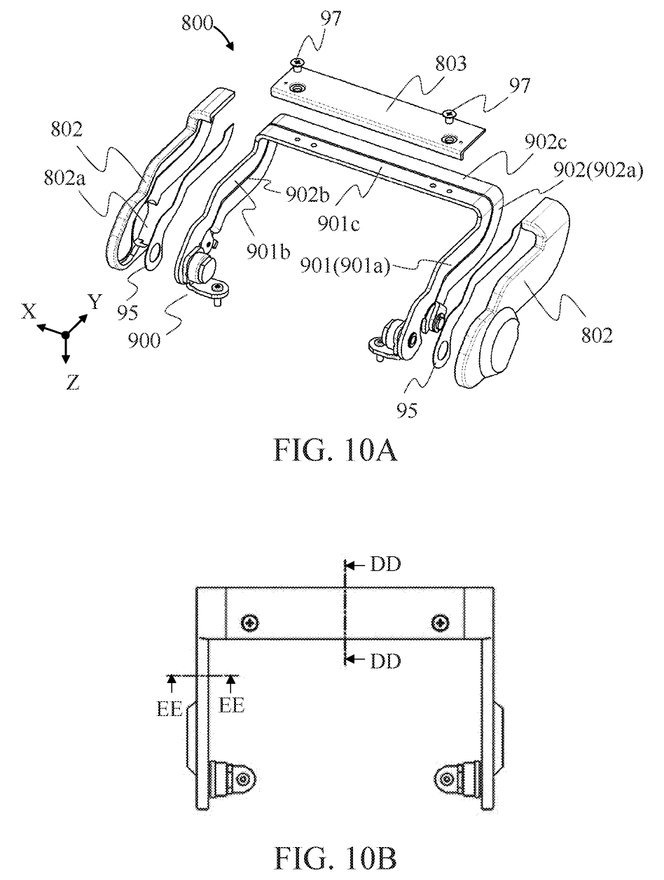

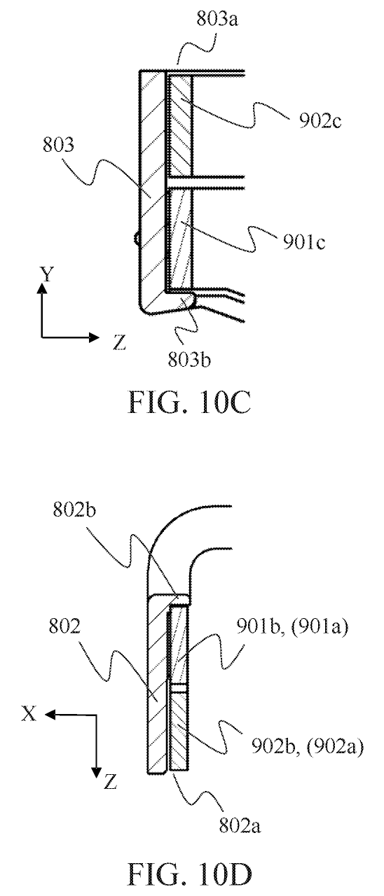

FIG. 10A illustrates an exploded perspective view of the stand 800 including the stand hinge 900. The stand hinge 900 has the same structure as that of the first embodiment. FIG. 10C illustrates a cross-sectional view taken along a line DD-DD in FIG. 10B, which is a rear view of the stand 800, and FIG. 10D illustrates a cross-sectional view taken along a line EE–EE in FIG. 10B.

While the stand 800 in the stored state is disposed in the rear grip region 42, the stand hinge 900, which mainly consists of sheet metal parts, has low gripping performance. Therefore, resin covers (802, 803) are attached to the stand hinge 900 so as to cover it.

The stand 800 includes the stand hinge 900, a pair of side covers 802, and an intermediate cover 803. The pair of side covers 802 is pasted and fixed to arm portions 901a and 901b of the first support member 901 with double-sided tape 95. The side covers 802 have a size that allows them to cover not only the arm portions 901a and 901b of the first support member 901 but also arm portions 902a and 902b of the second support member 902 in the stored state. Thereby, as illustrated in FIGS. 7B and 10B, side surfaces and front and rear end surfaces of the arm portions 901a, 901b, 902a, and 902b are covered.

The intermediate cover 803 is fixed to a coupling portion 901c of the first support member 901 by two screws 97. The intermediate cover 803 has a size that allows it to cover not only the coupling portion 901c of the first support member 901 but also a coupling portion 902c of the second support member 902 in the stored state. Thereby, as illustrated in FIGS. 1B and 5B, rear surfaces of the coupling portions 901c and 902c in the stored state are covered.

As illustrated in FIGS. 10C and 10D, in the stored state in which the first support member 901 and the second support member 902 are arranged close to each other, the side covers 802 and the intermediate cover 803 constitute the exterior surface of the camera 100. The side covers 802 and the intermediate cover 803 are provided with extending portions 802b and 803b extending toward the first support member 901, and these extending portions 802b and 803b cover lower and upper end surfaces of the first support member 901. Also in the present embodiment, by arranging the first support member 901 and the second support member 902 close to each other in the stored state, it is unnecessary to cover end surfaces of the first and second support members on the sides facing each other with covers. Thereby, the area occupied by the stand 800 on the rear and side surfaces of the camera 100 can be suppressed.

On the other hand, on the sides of the side covers 802 and the intermediate cover 803 opposite to the sides provided with the extending portions 802b and 803b (i.e., on the second support member 72 side), openings 802a and 803a are provided to allow rotation of the second support member 902 relative to the first support member 901.

In the stored state, since the display unit 5 is located above the opening 803a of the intermediate cover 803, the opening 803a is less visible to the user. On the other hand, the opening 802a of the side cover 802 opens toward the front side.

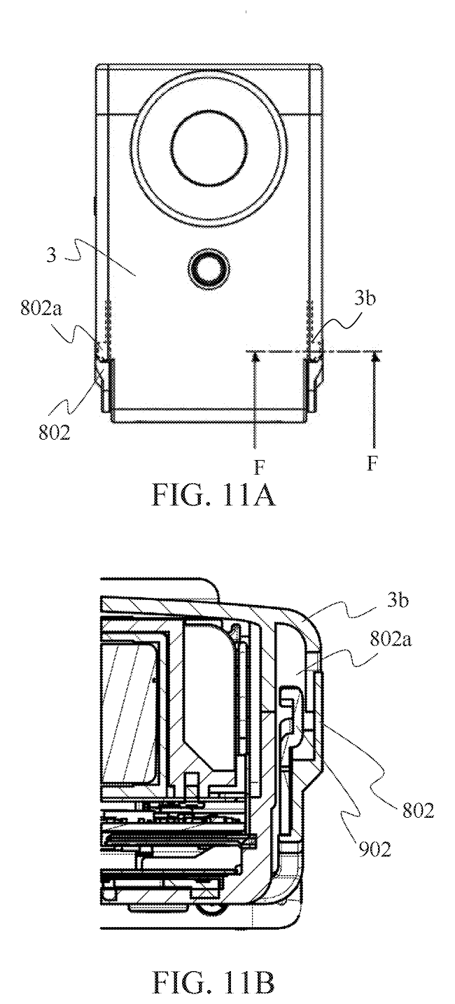

FIG. 11A illustrates the camera 100 in which the stand 800 is in the stored state when viewed from the front side. FIG. 11B illustrates a cross-sectional view taken along a line F-F in FIG. 11A. As illustrated in FIGS. 11A and 11B, extending portions 3b extending laterally from upper ends on both left and right sides of the front cover 3 to the lower side of the axis A3 are provided. The extending portions 3b cover the opening 802a of the side cover 802 when viewed from the front side, which is the direction toward the imaging system (lens unit 2). Thereby, in the stored state in which the opening 802a of the side cover 802 opens toward the front side, the second support member 902 disposed inside the opening 802a is not visible from the front side.

In the present embodiment described above, in the stored state of the stand 800, the outer surface of the stand 800, which forms the exterior appearance of the camera 100 and serves as a grip region to be held by the user, is constituted by the covers (802, 803). Thereby, the appearance of the camera 100 and gripping performance can be improved.

In the present embodiment, in the stored state, the arm portions 902a and 902b of the second support member 902 are disposed in front of the arm portions 901a and 901b of the first support member 901, and the coupling portion 902c of the second support member 902 is disposed above the coupling portion 901c of the first support member 901. Thereby, since the opening 802a of the side cover 802 faces the front side, by providing the extending portions 3b on the front cover 3, the opening 802a and its interior can be invisible from the front side. As a result, when the camera 100 is viewed from the front side, only a small portion of the stand 800 is visible, thereby improving the appearance of the camera 100. In the first and second usage modes, portions of the first and second support members 901 and 902 that are not covered by the covers are visible to the user; however, by applying decorative treatments such as painting or plating to those portions, the appearance can be improved.

By adopting a structure in which inner surfaces of the first and second support members 901 and 902 and end surfaces on sides where they approach each other are not covered with covers, an increase in the size of the camera 100 can be suppressed.

In the present embodiment, in the stored state, the second support member 902 is covered by the side covers 802 and the intermediate cover 803 fixed to the first support member 901. Therefore, transitioning the stand 800 from the stored state to the first usage mode can prevent the user from mistakenly rotating only the second support member 902.

The pair of side covers 802 and the intermediate cover 803 may be formed as an integral molded part. Each of the covers (802, 803) may be fixed not only by double-sided tape or screws but also by heat caulking.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an image pickup apparatus including a stand that imposes fewer restrictions on the tilt of the body.

This application claims the benefit of Japanese Patent Application No. 2025-042602, filed on Mar. 17, 2025, and which is hereby incorporated by reference herein in its entirety.

What is claimed is:

1. An image pickup apparatus comprising:
a body including an imaging system; and
a stand provided on the body,
wherein the stand includes a first stand rotatably held by the body and a second stand rotatably held by the first stand,
wherein the first stand and the second stand are rotatable among a stored state in which the first stand and the second stand are stored in the body, a first stand state in which the first stand and the second stand extend to the same side with respect to the body and at least one of the first stand and the second stand contacts an installation surface together with the body to support the body, and a second stand state in which the first stand and the second stand extend to opposite sides with respect to the body and respectively contact the installation surface to support the body, and
wherein the stand holds the body at a plurality of rotation angles in each of the first stand state and the second stand state such that directions of an optical axis of the imaging system differ from each other.

2. The image pickup apparatus according to claim 1, wherein, in the second stand state, the stand supports the body such that the body does not contact the installation surface.

3. The image pickup apparatus according to claim 1, wherein the plurality of rotation angles include rotation angles at which the optical axis is oriented upward and downward relative to a horizontal direction.

4. The image pickup apparatus according to claim 1, wherein, from the stored state to the first stand state, the second stand rotates together with rotation of the first stand, and
wherein, from the first stand state to the second stand state, one of the first stand and the second stand rotates independently of the other.

5. The image pickup apparatus according to claim 1, wherein a torque required to rotate the first stand is greater than a torque required to rotate the second stand.

6. The image pickup apparatus according to claim 1, wherein the body has a front surface on which the imaging system opens,
wherein each of the first stand and the second stand includes a pair of arm portions rotatable within planes along respective side surfaces of the body, and a coupling portion connecting the pair of arm portions, and
wherein, in the stored state, the coupling portion of the first stand and the coupling portion of the second stand are stored on a rear surface side of the body opposite to the front surface.

7. The image pickup apparatus according to claim 6, wherein, in the stored state, the coupling portion of the first stand and the coupling portion of the second stand are stored along a rear surface so as not to overlap each other in a front-rear direction.

8. The image pickup apparatus according to claim 6, wherein, in the stored state, the arm portions of the first stand and portions of the arm portions of the second stand other than portions rotatably held by the first stand are stored so as not to overlap each other in a rotation-axis direction.

9. The image pickup apparatus according to claim 1, wherein the body includes, on a bottom surface facing the installation surface, at least one of a battery lid configured to open and close an opening of a battery chamber, and an attachment portion configured to attach the body to an accessory.

10. The image pickup apparatus according to claim 1, wherein, in the stored state, an exterior member provided on the first stand covers the second stand.

11. The image pickup apparatus according to claim 1, wherein, when the image pickup apparatus in the stored state is viewed from a front side on which the imaging system opens, an extending portion provided on the body covers at least a part of a portion of the stand disposed on a side surface of the body.

12. An image pickup apparatus comprising:
a body including an imaging system; and
a stand provided on the body,
wherein the stand includes a first stand rotatably held by the body and a second stand rotatably held by the first stand,
wherein the first stand and the second stand are rotatable among a stored state in which the first stand and the second stand are stored in the body, and a stand state in which the first stand and the second stand extend to opposite sides with respect to the body and respectively contact an installation surface to support the body, and
wherein the stand holds the body at a plurality of rotation angles in the stand state such that directions of an optical axis of the imaging system differ from each other.

13. The image pickup apparatus according to claim 12, wherein, in the stand state, the stand supports the body such that the body does not contact the installation surface.
